(19) United States
(12) Patent Application Publication
(10) Pub. No.: US 2020/0171902 A1
(43) Pub. Date: Jun. 4, 2020

(54) ELECTRIC TRAILER DOLLY AND METHOD

(71) Applicant: Corey Bailey, Medicine Hat (CA)

(72) Inventor: Corey Bailey, Medicine Hat (CA)

(21) Appl. No.: 16/212,736

(22) Filed: Dec. 7, 2018

(30) Foreign Application Priority Data
Nov. 29, 2018 (CA) 3025755

(51) Int. Cl. B60D 1/66; B60D 1/06; B60K 7/00; B60K 17/04; B60K 1/04

(52) U.S. Cl. CPC B60D 1/665; B60D 1/06; B60K 2001/0416; B60K 17/043; B60K 1/04; B60K 7/0007

(57) ABSTRACT

A vehicle for towing and steering a trailer; the vehicle includes a chassis, a tow hitch interface, at least three wheels, an electric drive, and a handle. The tow hitch interface may be rigidly affixed to the chassis and may be able to interface with the tow hitch receiver of a trailer. The wheels may be rotatably attached to the chassis and may include at least one drive wheel which may be able to drive the vehicle and the trailer. The electric drive may be able to drive the at least one drive wheel along a drive-axis which is axial to the drive-wheel. The electric drive may include an electric motor, a power source, and a transmission. The handle may be mounted to the chassis and may be able to be used by a user to steer the vehicle.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicles of existing art and more specifically relates to towing means.

### RELATED ART

Trailers are an efficient and cost-effective way of storing and moving cargo. While trailers vary in size, many are extremely large as necessitated by the cargo they are designed for. When attached to a towing vehicle, the total length becomes even larger. This presents problems in tight areas, particularly in metropolitan areas, where trailers may need to be maneuvered, unloaded, or stored. Significant operator skill is necessary to maneuver a vehicle and trailer in such tight conditions, if it is possible at all. A suitable solution is desired.

U.S. Pat. No. 9,126,644 to Donald D. Banwart relates to a powered converter dolly and securing device. The described powered converter dolly and securing device includes a conventional converter trolley having a drawbar. The trolley has a power supply and operates as a towing device. The trolley connects to a freight trailer and can be raised or lowered from a stored position to a ground-engaging, working position. Alternatively, the wheels of the trolley may be powered for providing motion to the trolley. The trolley further comprises several attachment devices for securing the trolley to an intermodal railcar, including alternative hydraulic, mechanical, and electrically-powered tie down devices.

### SUMMARY OF THE INVENTION

In view of the foregoing disadvantages inherent in the known towing vehicle art, the present disclosure provides a novel electric trailer dolly and method. The general purpose of the present disclosure, which will be described subsequently in greater detail, is to provide an efficient and effective electric trailer dolly for use.

A vehicle for towing and steering a trailer having a tow hitch receiver is disclosed herein. The vehicle includes a chassis, a tow hitch interface, at least three wheels, an electric drive, and a handle. The tow hitch interface is rigidly affixed to the chassis and is able to interface with the tow hitch receiver of a trailer. The wheels are rotatably attached to the chassis and may include at least one drive wheel which may be able to drive the vehicle and the trailer. The electric drive is able to drive the at least one drive wheel along a drive-axis which is axial to the drive-wheel. The electric drive includes an electric motor, a power source, and a transmission. The power source is able to selectively provide current to the electric motor, while the transmission selectively transmits power from the electric motor to the drive wheel. The handle is mounted to the chassis and may be able to be used by a user to steer the vehicle. Certain embodiments may comprise wheelie bar(s) on the backend of the device to improve stabilization during use. Further embodiments may also comprise: BLUETOOTH capability; lights; a fifth wheel adapter/quick attach fifth wheel adapter; a multi-speed motor (2 or more); remote control capability; interchangeable ball hitches for various sizes/conversions. Both light-duty and heavy-duty versions may be available for manufacture.

According to another embodiment, a method of towing and steering a trailer is also disclosed herein. The method of towing and steering a trailer includes providing the above-described vehicle; affixing the tow hitch receiver of the trailer to the tow hitch interface of the vehicle; activating the electric motor of the vehicle to drive the at least one drive-wheel of the vehicle; steering the vehicle by applying leverage to the handle; and deactivating the electric motor when a destination is reached.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electric towing dolly and method, constructed and operative according to the teachings of the present disclosure.

FIG. 1 is a perspective view of the vehicle during an ‘in-use’ condition, according to an embodiment of the disclosure.

FIG. 2 is a perspective view of the vehicle of FIG. 1, according to an embodiment of the present disclosure.

FIG. 3 is a side perspective view of the vehicle of FIG. 1, according to an embodiment of the present disclosure.

FIG. 4 is a top perspective view of the vehicle of FIG. 1, according to an embodiment of the present disclosure.

FIG. 5 is a flow diagram illustrating a method of use for towing and steering a trailer, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a towing vehicle and more particularly to an electric trailer dolly and method as used to improve the towing and steering of a trailer via an efficient means.

Generally, the electric trailer dolly is an electrically powered vehicle having a tow hitch that may secure to and tow a trailer. The electric trailer dolly much simpler and smaller than a conventional towing vehicle, such as a pickup truck, and therefore is advantageous in its compactness and ability to maneuver a trailer in tight spaces. The electric towing dolly may also be cost-effective, easy-to-use, and clean. As the electric towing dolly does not produce emissions as an internal combustion engine does, it may more safely be used indoors, such as on a showroom floor. The device is hand-operated and able to move within tight quarters.

The electric towing dolly is essentially a vehicle having a chassis, a tow hitch interface connected to the chassis, a handle to steer the chassis, and a drive system. The drive system may include at least three wheels, with at least one of the wheels being a drive wheel able to propel the vehicle. The drive system may further include an electric motor (or the like), a power source to turn the electric motor, and a transmission able to transmit motion from the electric motor to the drive wheel. The vehicle may be propelled forwards or backwards and steered according to operator desire via hand manipulation.

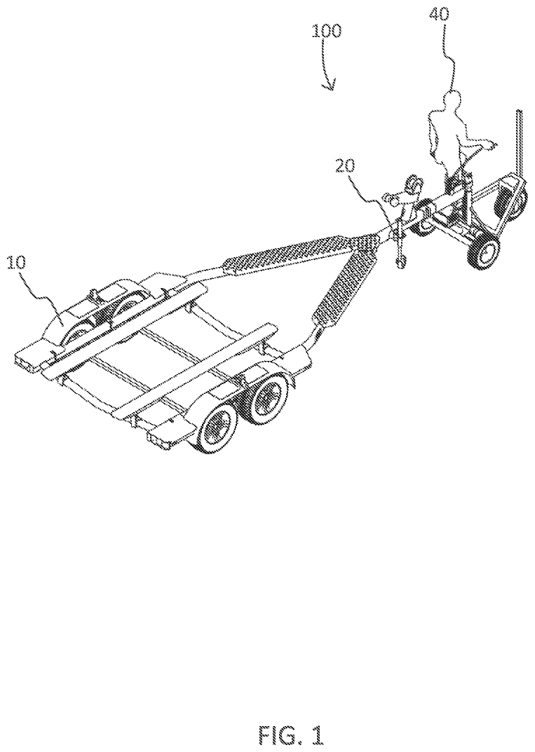

Referring now more specifically to the drawings by numerals of reference, there is shown in FIGS. 1-4, various views of a vehicle 100.

FIG. 1 shows a vehicle during an ‘in-use’ condition, according to an embodiment of the present disclosure. Here, the vehicle may be beneficial for use by a user 40 to move and steer a trailer. As illustrated, the vehicle 100 may be able to tow trailer 10 having trailer hitch receiver 20.

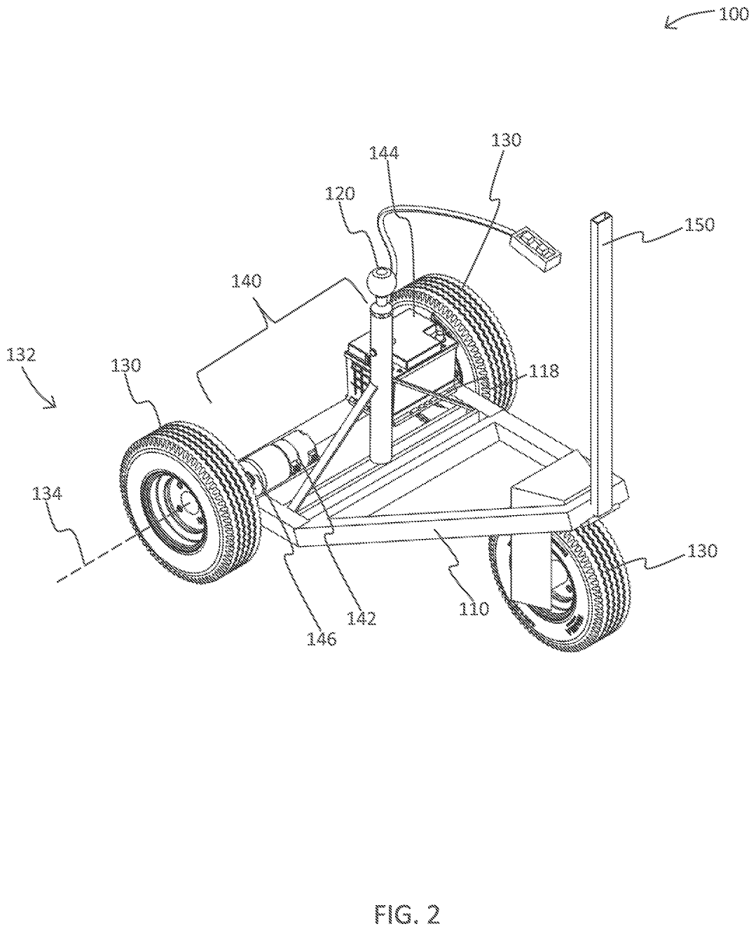

Referring now to FIG. 2 showing the vehicle 100 of FIG. 1, according to an embodiment of the present disclosure. As above, the vehicle 100 may include chassis 110, tow hitch interface 120, at least three wheels 130, electric drive 140, and handle 150. Tow hitch interface 120 may be rigidly affixed to chassis 110. At least three wheels 130 may be rotatably mounted to chassis 110 and may include at least one drive-wheel 132 as shown. Some embodiments may incorporate multiples of drive wheel 132, or more than three wheels 130 in total. Electric drive 140 may be configured to drive at least one drive-wheel 132 along drive-axis 134, drive-axis 134 being axial to the drive-wheel.

Electric drive 140 may itself include electric motor 142, power source 144, and transmission 146 operating in functional combination to drive vehicle 100 and, optionally, trailer 10 when trailer 10 is engaged to tow hitch interface 120. Power source 144 may be able to selectively provide current to electric motor 142, while transmission 146 may be able to transmit power from electric motor 142 to at least one drive-wheel 132. Handle 150 may be affixed to chassis 110, handle 150 being configured to manually steer chassis 110. In a preferred embodiment, handle 150 is removably and pivotably attached to chassis 110. In some embodiments, vehicle 100 may further include battery support 118 rigidly affixed to chassis 110, battery support 118 being configured to support and retain power source 144 upon chassis 110. In one embodiment, transmission 146 may be a gear-drive having a first-gear mounted to at least one drive-wheel 132 and a second-gear mounted to electric motor 142. In alternative embodiments, transmission 146 may be a belt-drive or a chain-drive engaging both of at least one drive-wheel 132 and electric motor 142. In some embodiments, handle 150 is tubular, and may be constructed of steel. Handle 150 may be constructed more specifically of square tubular stock. In some embodiments, chassis 110 is made of steel, and may also be constructed of square tubular stock or the like. Other materials and geometries may be used to construct handle 150 and chassis 110, such as round tubular stock, angle iron, flat stock, castings, forgings, and others.

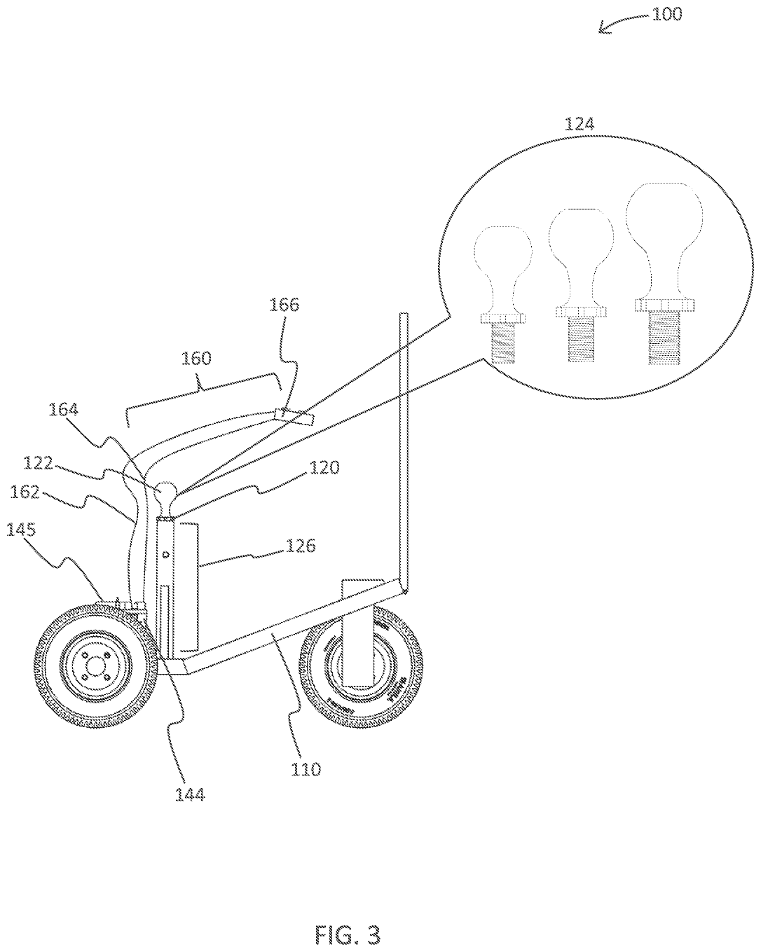

FIG. 3 is a side perspective view of the vehicle 100 of FIG. 1, according to an embodiment of the present disclosure. As shown, tow hitch interface 120 may be tow ball 122. Preferably, tow hitch interface 120 is removably attached to chassis 110. In this way, alternative embodiments and sizes 124 of tow hitch 120 may be interchanged from vehicle 100. In some embodiments, tow hitch interface 120 may be threadably connected to chassis 110. Preferably, power source 144 is lead-acid battery 145 as shown. Power source 144 is preferably a twelve-volt power source, and is preferably direct current. Alternative embodiments may incorporate other forms of power source 144, such as capacitors and power adapters to external power sources. In some embodiments, vehicle 100 may further include circuit 160.

Circuit 160 may include negative direct-current conduit 162, positive direct-current conduit 164, and switch 166. Negative direct-current conduit 162 may electrically couple power source 144 to electric motor 142 (FIG. 2). While positive direct-current conduit 164 may also electrically couple power source 144 to electric motor 142 (FIG. 2). Switch 166 may be able to interrupt circuit 160, as desired, referably, electric motor 142 is a direct-current motor that may spin either clockwise or counter-clockwise depending on polarity. Preferably, circuit 160 may further include a means for reversing polarity, such that electric motor 142 may selectively be spun in either direction, thereby propelling vehicle 100 either forward or backward. In some embodiments, switch 166 may interrupt negative direct-current conduit 162 or positive direct-current conduit 164. Switch 166 may be a toggle switch in one embodiment. In the embodiment shown, switch 166 may be a pair of radio buttons. Some embodiments may include two of switch 166 for selecting forward and backward drive directions. Other forms of switch 166 may be used. In some embodiments, vehicle 100 may further include hitch extension 126 vertically separating tow hitch interface 120 from chassis 110, hitch extension 126 being rigidly connected to both chassis 110 and tow hitch interface 120.

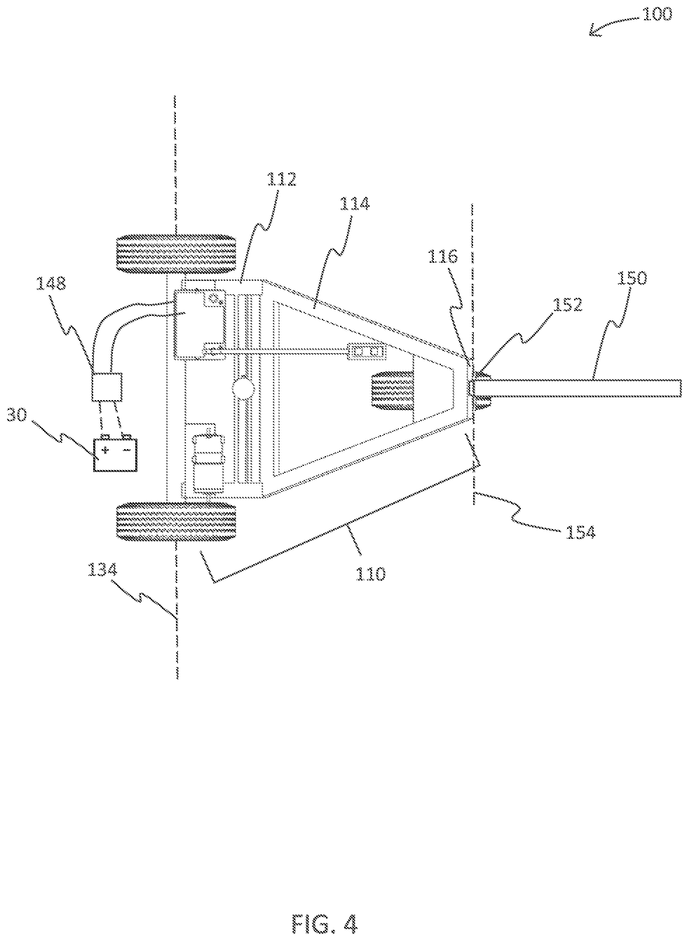

Referring now to FIG. 4 a top perspective view of the vehicle 100 of FIG. 1, according to an embodiment of the present disclosure. In some embodiments, vehicle 100 may further include hinge 152 able to swing along hinge-axis 154, hinge 152 attaching handle 150 to chassis 110, such that hinge-axis 154 is substantially parallel to drive-axis 134. In a preferred embodiment, chassis 110 may include first frame member 112, and second frame member 114, and third frame member 116 rigidly affixed to each other, such that first frame member 112, second frame member 114, and third frame member 116 form a triangular frame. In some embodiments, power source 144 may comprise or include adapter 148. Adapter 148 may be able to electrically couple electric motor 142 to vehicle battery 30. Upon reading this specification, it should be appreciated that, under appropriate circumstances, considering such issues as user preferences, design preference, structural requirements, marketing preferences, cost, available materials, technological advances, etc., other structural arrangements such as, for example, additional chassis features and geometries, additional drivetrain means, etc., may be sufficient.

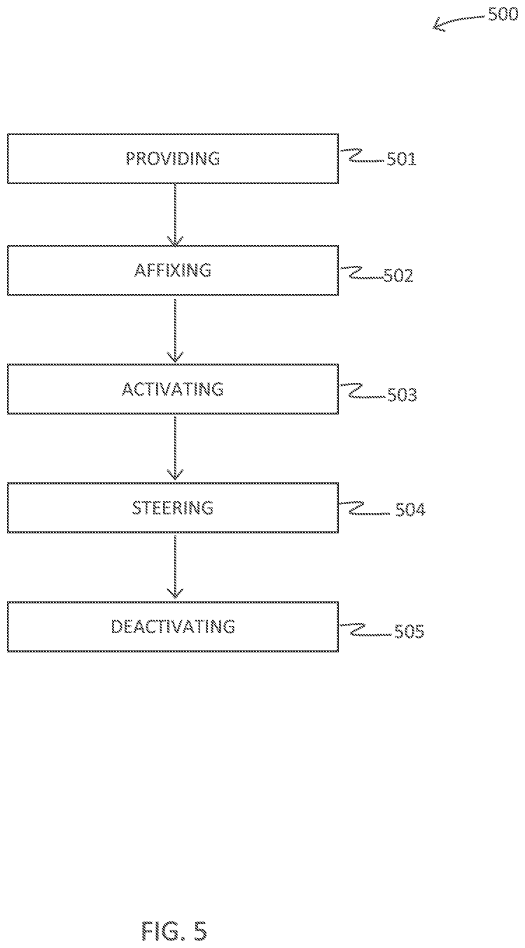

Referring now to FIG. 5 showing a flow diagram illustrating a method for towing and steering a trailer 500, according to an embodiment of the present disclosure. In particular, the method for towing and steering a trailer 500 may include one or more components or features of the vehicle 100 as described above. As illustrated, the method for towing and steering a trailer 500 may include the steps of: step one 501, providing a vehicle able to tow a trailer having a trailer hitch receiver, the vehicle comprising: a chassis, a tow hitch interface rigidly affixed to the chassis, the tow hitch interface being configured to interface with the trailer hitch receiver, at least three wheels, the at least three wheels being rotatably mounted to the chassis, the at least three wheels including at least one drive-wheel, an electric drive, the electric drive being configured to drive the at least one drive-wheel along a drive-axis, the drive-axis being axial to the drive-wheel, the electric drive having an electric motor, a power source able to selectively provide current to the electric motor, and a transmission able to transmit power from the electric motor to the at least one drive-wheel, and a handle affixed to the chassis, the handle being configured to manually steer the chassis; step two 502, affixing the tow hitch of the trailer to the tow hitch interface of the vehicle; step three 503, activating the electric motor of the vehicle to drive the at least one drive-wheel of the vehicle step four 504, steering the vehicle by applying leverage to the handle; and step five 505, deactivating the electric motor when a destination is reached.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for towing and steering a trailer, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle able to tow a trailer having a trailer hitch receiver, the vehicle comprising:
a chassis;
a tow hitch interface rigidly affixed to the chassis, the tow hitch interface being configured to interface with the trailer hitch receiver;
at least three wheels, the at least three wheels being rotatably mounted to the chassis, the at least three wheels including at least one drive-wheel;
an electric drive, the electric drive being configured to drive the at least one drive-wheel along a drive-axis, the drive-axis being axial to the drive-wheel, the electric drive having
an electric motor,
a power source able to selectively provide current to the electric motor, and
a transmission able to transmit power from the electric motor to the at least one drive-wheel; and
a handle affixed to the chassis, the handle being configured to manually steer the chassis.

2. The vehicle of claim 1, further comprising a hinge able to swing along a hinge-axis, the hinge attaching the handle to the chassis, such that the hinge-axis is substantially parallel to the drive-axis.

3. The vehicle of claim 1, wherein the tow hitch interface is a tow ball.

4. The vehicle of claim 1, wherein the tow hitch interface is removably attached to the chassis, such that alternate sizes of said tow hitch interface may be interchanged.

5. The vehicle of claim 1, wherein the chassis includes a first frame member, and a second frame member, and a third frame member rigidly affixed to each other, such that the first frame member, the second frame member, and the third frame member form a triangular frame.

6. The vehicle of claim 1, wherein the power source is a lead-acid battery.

7. The vehicle of claim 1, wherein the power source includes an adapter able to electrically couple the electric motor to a vehicle battery.

8. The vehicle of claim 1, further comprising a circuit having
a negative direct-current conduit electrically coupling the power source to the electric motor;
a positive direct-current conduit electrically coupling the power source to the electric motor; and
a switch able to interrupt the circuit, as desired.

9. The vehicle of claim 1, further comprising a hitch extension vertically separating the tow hitch interface from the chassis, the hitch extension being rigidly connected to both the chassis and the tow hitch interface.

10. The vehicle of claim 1, further comprising a battery support rigidly affixed to the chassis, the battery support being configured to support and retain the power source upon the chassis.

11. The vehicle of claim 1, wherein the transmission is a gear-drive having a first-gear mounted to the at least one drive-wheel and a second-gear mounted to the electric motor.

12. The vehicle of claim 1, wherein the transmission is a belt-drive engaging the at least one drive-wheel and the electric motor.

13. The vehicle of claim 1, wherein the transmission is a chain-drive engaging the at least one drive-wheel and the electric motor.

14. The vehicle of claim 1, wherein the handle is tubular.

15. The vehicle of claim 1, wherein the handle is made of steel.

16. The vehicle of claim 1, wherein the chassis is made of steel.

17. A vehicle able to tow a trailer having a trailer hitch receiver, the vehicle comprising:
a chassis;
a tow hitch interface rigidly affixed to the chassis, the tow hitch interface being configured to interface with the trailer hitch receiver;
at least three wheels, the at least three wheels being rotatably mounted to the chassis, the at least three wheels including at least one drive-wheel;
an electric drive, the electric drive being configured to drive the at least one drive-wheel along a drive-axis, the drive-axis being axial to the drive-wheel, the electric drive having
an electric motor,
a power source able to selectively provide current to the electric motor, and
a transmission able to transmit power from the electric motor to the at least one drive-wheel; and
a handle affixed to the chassis, the handle being configured to manually steer the chassis;
further comprising a hinge able to swing along a hinge-axis, the hinge attaching the handle to the chassis, such that the hinge-axis is substantially parallel to the drive-axis;
wherein the tow hitch interface is a tow ball;
wherein the tow hitch interface is removably attached to the chassis, such that alternate sizes of said tow hitch interface may be interchanged;
wherein the chassis includes a first frame member, and a second frame member, and a third frame member rigidly affixed to each other, such that the first frame member, the second frame member, and the third frame member form a triangular frame;
wherein the power source is a lead-acid battery,
wherein the power source includes an adapter able to electrically couple the electric motor to a vehicle battery;
further comprising a circuit having
a negative direct-current conduit electrically coupling the power source to the electric motor,
a positive direct-current conduit electrically coupling the power source to the electric motor, and
a switch able to interrupt the circuit, as desired;
further comprising a hitch extension vertically separating the tow hitch interface from the chassis, the hitch extension being rigidly connected to both the chassis and the tow hitch interface;
further comprising a battery support rigidly affixed to the chassis, the battery support being configured to support and retain the power source upon the chassis;
wherein the handle is tubular,
wherein the handle is made of steel;
wherein the chassis is made of steel; and
wherein the handle is structured and arranged for an operator to operate the vehicle from a walking position.

18. A method of towing and steering a trailer, the method comprising the steps of:
providing a vehicle able to tow a trailer having a trailer hitch receiver, the vehicle comprising: a chassis, a tow hitch interface rigidly affixed to the chassis, the tow hitch interface being configured to interface with the trailer hitch receiver, at least three wheels, the at least three wheels being rotatably mounted to the chassis, the at least three wheels including at least one drive-wheel, an electric drive, the electric drive being configured to drive the at least one drive-wheel along a drive-axis, the drive-axis being axial to the drive-wheel, the electric drive having an electric motor, a power source able to selectively provide current to the electric motor, and a transmission able to transmit power from the electric motor to the at least one drive-wheel, and a handle affixed to the chassis, the handle being configured to manually steer the chassis;
affixing the tow hitch of the trailer to the tow hitch interface of the vehicle;
activating the electric motor of the vehicle to drive the at least one drive-wheel of the vehicle;
steering the vehicle by applying leverage to the handle; and
deactivating the electric motor when a destination is reached.
